(19) United States
(12) Patent Application Publication
(10) Pub. No.: US 2020/0154178 A1
(43) Pub. Date: May 14, 2020

(54) SOFTWARE VIDEO COMPILERS IMPLEMENTED IN COMPUTING SYSTEMS

(71) Applicant: Microsoft Technology Licensing, LLC, Redmond, WA (US)

(72) Inventor: Arun Satyarth, Bangalore (IN)

(21) Appl. No.: 16/190,421

(22) Filed: Nov. 14, 2018

(51) Int. Cl. H04N 21/8549; H04L 12/58; H04N 21/4788; H04N 21/6371

(52) U.S. Cl. CPC H04N 21/8549; H04L 51/10; H04N 21/6371; H04N 21/4788; H04L 51/32

(57) ABSTRACT

Software video compilers and associated processes of compiling electronic data are disclosed herein. In one embodiment, a software video compiler is configured to identify one or more electronic messages to be compiled. Upon identifying the electronic messages to be compiled, the software video compiler can compile the identified electronic messages into multiple frames of a video. The software video compiler can then provide data representing the video having the frames each containing one or more of the identified electronic messages to be presented to a user on a client device.

### BACKGROUND

A social networking service is a computer service that provides an online platform configured to allow people to build social networks or social relations with other people via a computer network such as the Internet. For example, a user can utilize a social networking service to broadcast posts via a social network account. Such posts can contain text, photos, videos, audios, or other suitable types of electronic messages. In response, other users of the social network service can repost, reply, comment, or perform other actions on the original posts. Such interactions can allow the users to share similar personal or career interests, activities, backgrounds, or real-life connections.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A social networking service typically provides various functionalities or features to facilitate communications with other users on a social network. For example, the social networking service can provide functionalities for a user to compose, edit, and publish various electronic messages or “posts” to a social network account. The social networking service can also provide functionalities to notify other users subscribing to the social network account of the user, and allow the other users to view, comment, repost, or like/dislike the published posts. In other examples, the social networking service can also provide functionalities for the user to view, browse, delete, edit, or perform other actions on posts previously composed and/or published by the same user.

When allowing the user to view previous posts, certain social networking services can provide functionalities to arrange the previous posts according in a temporal order linearly or overlaid as a “timeline” such that recent posts are shown before other less recent or “stale” posts. To browse the posts, the user can scroll through the timeline using mouse clicks, finger taps, or other suitable input mechanisms. The scrolling technique, however, can be inefficient and cumbersome when the user has hundreds or even thousands of posts on the timeline. The scrolling technique can also be imprecise because the user may skip a post of interest when fast scrolling through a large number of posts.

Several embodiments of the disclosed technology are directed to animation of posts on a timeline to enable ready and efficient viewing of the posts to a user. In certain embodiments, a social networking service can provide an interface element, such as a “play” button to a user. Upon receiving a user input actuating the play button, the social networking service can be configured to compile the posts on the timeline of the user into multiple frames, insert suitable animation transitions (e.g., fade in, fade out, etc.) between consecutive frames, and output data that represents the animated posts to the user via, for instance, a smartphone, tablet, or other suitable types of client device. The animated posts can include, for example, a slideshow or video of the multiple frames individually containing one or more of the posts of the user on the timeline.

Before compilation of the posts on the timeline, the social networking service can be configured to allow the user to select a subset of the posts on the timeline for the compilation based on certain criteria. For example, the social networking service can be configured to allow the user to select a date/time range of posts to be included in the animated posts. In other examples, the social networking service can also be configured to allow the user to select a subset of the posts based on one or more of a message type (e.g., original posts or response post), a message topic (e.g., weather, school, etc.), or content type (e.g., only textual content).

During compilation of the posts on the timeline, several embodiments of the disclosed technology can apply various processing operations to various types of content in the posts. For example, textual content in a post can be condensed to only show a beginning portion of a preset threshold number of characters or phrases. In another example, pictorial content may be processed with lossy compression to derive a thumbnail version of the pictorial content to be included in a frame instead of an original version of the pictorial content. In a further example, video content may be shortened and/or compressed to show a beginning portion or abbreviated version of a threshold duration (e.g., 10 seconds). In yet further examples, additional and/or different types of content may be filtered, converted, altered or otherwise modified suitably in order to derive a playable frame.

In accordance with embodiments of the disclosed technology, the social networking service can also be configured to provide navigational functionalities and/or interface elements during playback of the animated posts. In one implementation, the social networking service can be configured to provide one or more of a pause, resume, fast forward, rewind, or other suitable types of navigational functionalities. In other implementations, the social networking service can also be configured to provide editing functionalities during playback of the posts. For instance, the social networking service can be configured to provide functionalities and/or associated interface elements for modifying, deleting, reposting, or other suitable operations on the posts in the animation. In response to a user selection of such functionalities, the social networking service can be configured to re-compile, re-arrange, or otherwise re-generate at least a portion of the animated posts in the multiple frames immediately, upon receiving a “save” or “apply” command, or in other suitable manners. In further examples, the social networking service can be configured to provide a functionality and/or interface element to allow the user to cancel playback of the animation.

Several embodiments of the disclosed technology can thus provide an efficient technique for the user to browse through a large number of posts on the timeline without requiring the user to scroll through a large number of posts via multiple user inputs. Instead, with a single click, the user can be presented with an animation of the posts on the timeline. The animation automatically scrolls through the posts without further user input. During playback of the animation, when the user is presented with a desired post, the user can pause the playback and optionally perform deletion, modification, or other suitable actions on the post. As such, embodiments of the social networking service can provide enhanced user experience of the social networking service when communicating with other users on a social network. Embodiments of the disclosed technology can also improve operations of the client device. For instance, by reducing several scrolling requests from the client device to the social network and associated scrolling operations on the client device, compute usage of the client device and network bandwidth usage from the client device to the social network may be reduced.

### BRIEF DESCRIPTION OF THE DRAWINGS

FIG. 1 is a schematic diagram of a computing system implementing social networking services in a social network in accordance with embodiments of the disclosed technology.

FIGS. 2A-2D are schematic diagrams illustrating certain hardware/software components of the computing system at certain operating stages in accordance with embodiments of the disclosed technology.

FIGS. 3A and 3B are flowcharts illustrating processes of animation of user timeline in accordance with embodiments of the disclosed technology.

FIG. 4 is a computing device suitable for certain components of the distributed computing system in FIG. 1.

### DETAILED DESCRIPTION

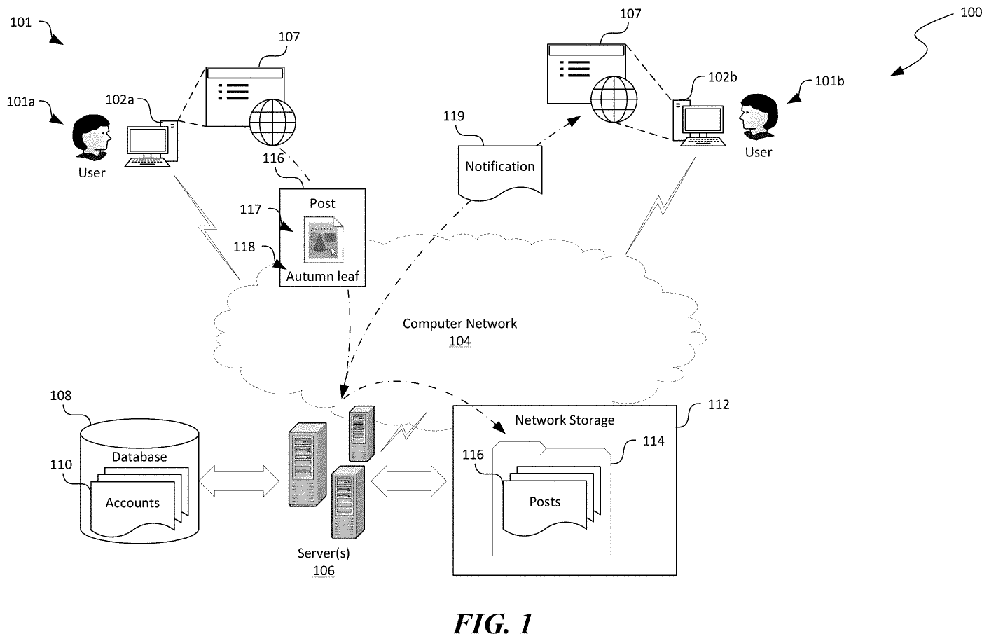

Certain embodiments of computing systems, devices, components, modules, routines, and processes for animation of posts on user timelines in computing systems are described below. In the following description, specific details of components are included to provide a thorough understanding of certain embodiments of the disclosed technology. A person skilled in the relevant art can also understand that the disclosed technology may have additional embodiments or may be practiced without several of the details of the embodiments described below with reference to FIGS. 1-4. Even though embodiments of the disclosed technology are described below in a context of distributed computing systems, embodiments of the disclosed technology can also be implemented in standalone desktop computers, laptop computers, or other suitable types of computing devices.

As used herein, a “social network” generally refers to an online computer platform configured to allow user to build social relations with other users on the social network. Example social networks can include Google+®, Facebook®, Instagram®, Twitter®, Snapchat®, and Linkedin®. The online computer platform of a social network can provide various computing services or social networking services to facilitate the building of social relations. For example, a user of a social network can publish electronic messages known as “posts” on the social network to be broadcasted and/or viewed by other users of the social network. A post can contain various content types. For instance, a post can contain one or more of textual, pictorial, video, or other suitable types of content. In another example, the social networking services can also be configured to provide a “timeline” of a user that contains multiple posts of the user arranged temporally, hierarchically, or in other suitable orders.

When browse posts on a timeline, a user typically can scroll through the posts on the timeline using mouse clicks, finger taps, or other suitable input mechanisms. The scrolling technique, however, can be inefficient and cumbersome when the user has hundreds or even thousands of posts on the timeline. The scrolling technique can also be imprecise because the user may skip a post of interest when fast scrolling through the large number of posts.

Several embodiments of the disclosed technology are directed to a software video compiler configured to animate posts on a timeline to enable ready viewing of the posts to a user. In certain implementations, a social networking service can provide an interface element, such as a “play” button to a user. Upon receiving a user input actuating the play button, the social networking service can be configured to compile some or all the posts on the timeline of the user into one or more frames of a video by, for example, inserting suitable animation transitions (e.g., fade in, fade out, etc.) between consecutive frames. The video can then be presented to a user on a client device. As such, the posts on the timeline can be automatically presented on the client device to the user without additional input from the user to scroll through the timeline, as described in more detail below with reference to FIGS. 1-4.

FIG. 1 is a schematic diagram illustrating a distributed computing system 100 implementing animation of user timelines in accordance with embodiments of the disclosed technology. As shown in FIG. 1, the computing system 100 can include a computer network 104 interconnecting a plurality of client devices 102 (shown as first and second client devices 102a and 102b, respectively) of corresponding users 101 (shown as first and second users 101a and 101b, respectively), and one or more computer servers 106 interconnected to a database 108 and a network storage 112. Even though particular components are shown in FIG. 1, in other embodiments, the computing system 100 can also include additional and/or different constituents. For example, the computing system 100 can include additional network storage devices, utility infrastructures, and/or other suitable components in addition to or in lieu of those shown in FIG. 1.

The computer network 104 can include an intranet, a wide area network, the Internet, or other suitable types of network. In certain implementations, the computer network 104 can include one or more physical network devices that interconnect the client devices 102 and the computer servers 106. Examples of such physical network devices can include network routers, switches, firewalls, load balancers, or other suitable network components operatively coupled in a hierarchical, flat, “mesh,” or other suitable topologies.

The client devices 102 can each include a computing device that facilitates corresponding users 101 to access social networking services provided by the servers 106 via the computer network 104. For example, in the illustrated embodiment, the client devices 102 individually include a desktop computer providing a user interface 107 for accessing the social networking services provided by the computer servers 106. In other embodiments, the client devices 102 can also include laptop computers, tablet computers, smartphones, or other suitable computing devices providing a webpage or other suitable types of user interface 107. Even though two users 101 are shown in FIG. 1 for illustration purposes, in other embodiments, the computing system 100 can facilitate any suitable number of users 101 to access suitable types of computing services provided by the servers 106.

The computer servers 106 can include one or more physical servers, virtual machines, or other suitable computing facilities that are configured to provide various social networking services to the users 101 via the computer network 104. For example, as shown in FIG. 1, the first user 101a can utilize the client device 102 to generate a post 116 to be published to a social network. For instance, the client device 102 can execute suitable instructions to provide the user interface 107 having functionalities such as composing a textual message, selecting an image or video from the client device 102a, and/or other suitable functions. In the illustrated example, the generated post 116 includes an image 117 and text 118 of “Autumn leaf.” In other examples, the post 116 can also include videos, documents, or other suitable types of content.

Upon completion of generating the post 116, the first user 101a can publish the generated post 116 to the social network by transmitting data representing the post 116 to the computer servers 106 via the computer network 104. In response to receiving the post 116, the computer servers 106 can be configured to associate the received post 116 with a user account of the first user 101a according to records of accounts 110 in the database 108 and store a copy of the received post 116 in a corresponding folder 114 of the first user 101a in the network storage 112. The computer servers 106 can also be configured to provide notification(s) 119 of the received post 116 to any other users 101 (e.g., the second user 101b) who subscribe or otherwise to receive posts 116 from the first user 101a. Upon receiving input from the second user 101b for viewing the post 116, the computer servers 106 can be configured to provide a copy of the post 116 to the second user 101b.

The computer servers 106 can also be configured to generate a timeline of the first user 101a by aggregating some or all posts 116 that have been received from the first user 101a. In one implementation, the timeline can include a corresponding interface element that lists all posts 116 of the first user 101a temporally or in other suitable orders. The computer serves 106 can further be configured to present the timeline to the first user 101a upon user request. In certain implementations, when browse through posts 116 on a timeline, the first user 101a may need to scroll through the posts 116 one by one on the timeline using mouse clicks, finger taps, or other suitable input mechanisms. The scrolling technique, however, can be inefficient and cumbersome when the first user 101a has hundreds or even thousands of posts on the timeline. The scrolling technique can also be imprecise because the first user 101a may skip a post 116 of interest when fast scrolling through the large number of posts 116.

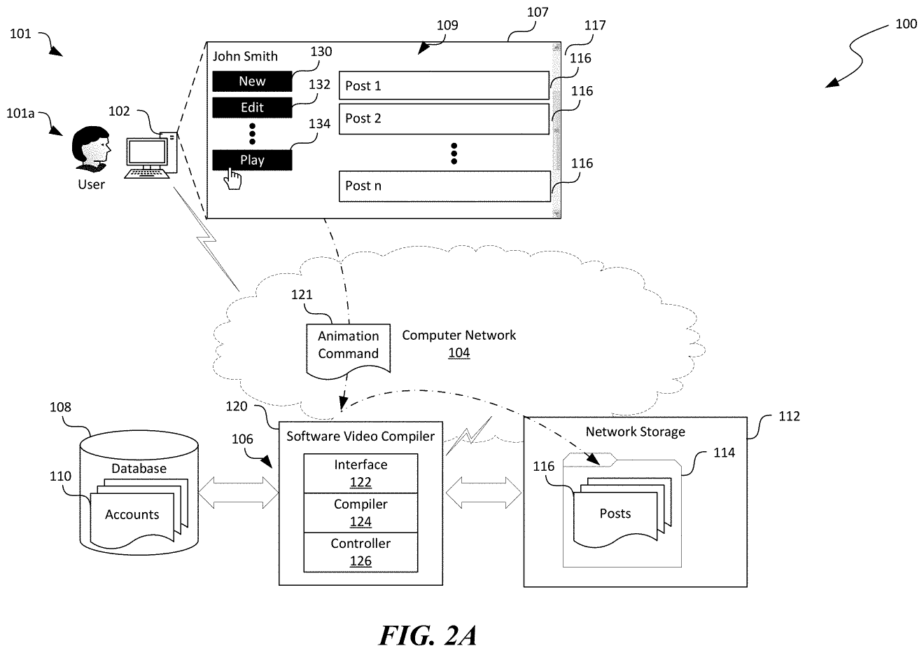

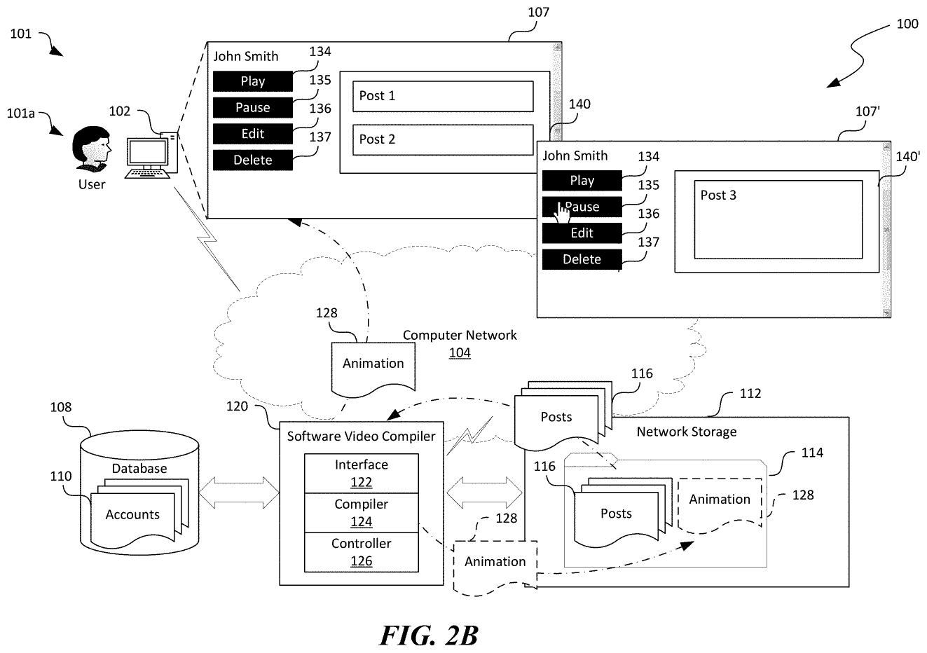

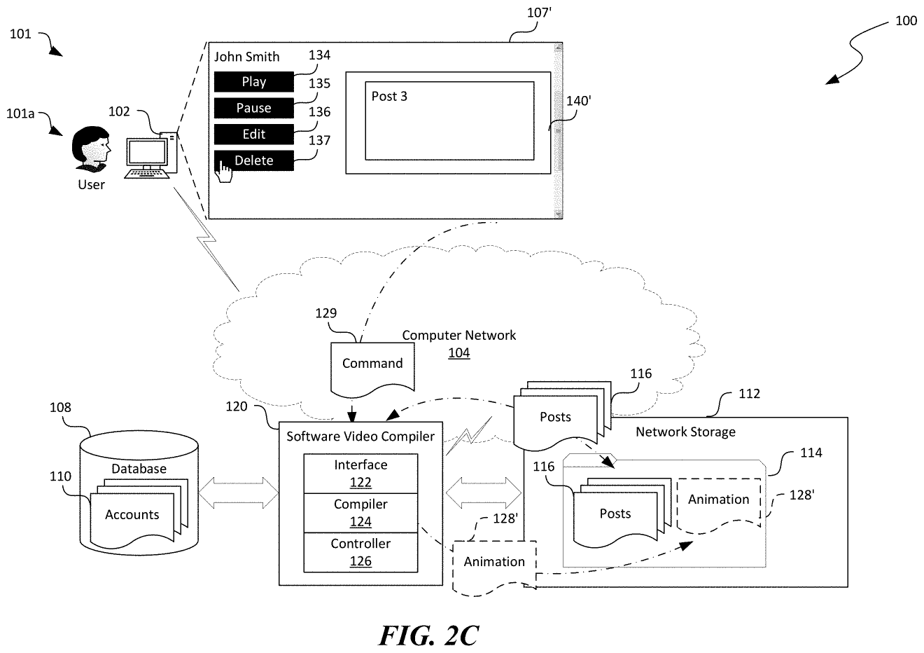

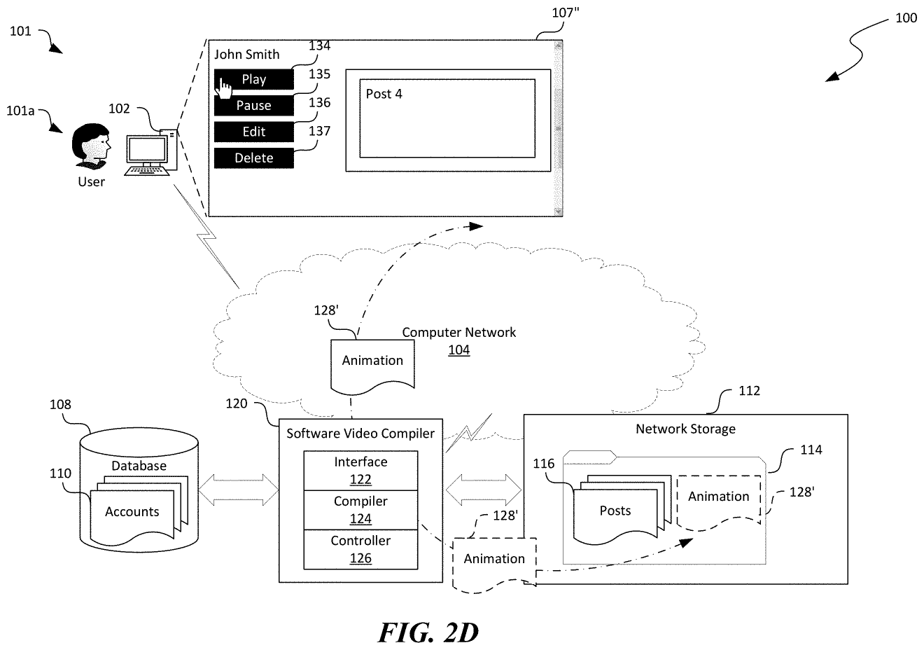

In accordance with embodiments of the disclosed technology, the computer servers 106 can include a software video compiler 120 (shown in FIG. 2A) that is configured to create and animate some or all of the posts 116 of the first user 101a to enable ready viewing of the posts 116 to the first user 101a. In certain implementations, the user interface 107 can provide an interface element, such as a “play” button (not shown) to the first user 101a. Upon receiving a user input actuating the play button, the client device 102 can transmit the user input to the computer servers 106. In turn, the computer servers 106 can be configured to compile some or all of the posts 116 on the timeline of the user into one or more frames of a video by, for example, converting format of data associated with each post 116, inserting suitable animation transitions (e.g., fade in, fade out, etc.) between consecutive frames, or perform other suitable operations. The video can then be transmitted to the client device 102 and presented to the first user 101a on the client device 102. As such, the posts 116 on the timeline can be automatically presented on the client device 102 to the first user 101a without additional input from the first user 101a to, for example, scroll through the timeline, as described in more detail below with reference to FIGS. 2A-2D.

FIGS. 2A-2D are schematic diagrams illustrating certain hardware/software components of the computing system 100 during various stages of animating user timeline in accordance with embodiments of the disclosed technology. In FIGS. 2A-2D, only certain components of the computing system 100 of FIG. 1 are shown for clarity. In FIG. 2A and in other Figures herein, individual software components, objects, classes, modules, and routines may be a computer program, procedure, or process written as source code in C, C++, C#, Java, and/or other suitable programming languages. A component may include, without limitation, one or more modules, objects, classes, routines, properties, processes, threads, executables, libraries, or other components. Components may be in source or binary form. Components may include aspects of source code before compilation (e.g., classes, properties, procedures, routines), compiled binary units (e.g., libraries, executables), or artifacts instantiated and used at runtime (e.g., objects, processes, threads). In certain embodiments, the various components and modules described below can be implemented with actors. In other embodiments, generation of the application and/or related services can also be implemented using monolithic applications, multi-tiered applications, or other suitable components.

Components within a system can take different forms within the system. As one example, a system comprising a first component, a second component and a third component can, without limitation, encompass a system that has the first component being a property in source code, the second component being a binary compiled library, and the third component being a thread created at runtime. The computer program, procedure, or process may be compiled into object, intermediate, or machine code and presented for execution by one or more processors of a personal computer, a network server, a laptop computer, a smartphone, and/or other suitable computing devices. Equally, components may include hardware circuitry.

A person of ordinary skill in the art would recognize that hardware may be considered fossilized software, and software may be considered liquefied hardware. As just one example, software instructions in a component may be burned to a Programmable Logic Array circuit or may be designed as a hardware circuit with appropriate integrated circuits. Equally, hardware may be emulated by software. Various implementations of source, intermediate, and/or object code and associated data may be stored in a computer memory that includes read-only memory, random-access memory, magnetic disk storage media, optical storage media, flash memory devices, and/or other suitable computer readable storage media excluding propagated signals.

As shown in FIG. 2A, the client device 102 can be configured to provide a user interface 107 for facilitating operations of the social networking services provided by the computer servers 106. In the illustrated example, the user interface 107 can include control elements such as “New,” “Edit,” and “Play” buttons 130, 132, and 134. The user interface 107 can also include a display area for outputting a timeline 109 of the first user 101a as a list of posts 116 arranged temporally or in other suitable orders. The user interface 107 can further include navigational elements such as a scroll bar 117 that allows the first user 101a to scroll up/down through the timeline 109.

In accordance with aspects of the disclosed technology, upon receiving a user input (as indicated by the cursor) on the “Play” button 134, the user interface 107 (or other suitable components of the client device 102) can be configured to generate and transmit an animation command 121 to a software video compiler 120 provided by the computer servers 106 via the computer network 104. As described in more detail below, the software video compiler 120 can be configured to compile some or all of the posts 116 the first user 101a has published to the social network into a video or slideshow, and thus providing efficient browsing of the posts 116.

As shown in FIG. 2A, the software video compiler 120 can include an interface component 122, a compiler 124, and a controller 126 operatively coupled to one another. Though particular components of the software video compiler 120 is shown in FIG. 2A and other figures herein, in some embodiments, at least one of the foregoing components may be separate from the software video compiler 120. For example, in certain implementations, the controller 126 may be a part of the user interface 107 or other suitable components of the client device 102.

The interface component 122 can be configured to communicate with the client device 102 via the computer network 104. For example, the interface component 122 can be configured to receive the animation command 121 and forward the animation command 121 to the compiler 124 for further processing. Also, the interface component 122 can be configured to transmit data representing, for instance, the timeline 109, posts 116, or other suitable information to the client device 102. The interface component 122 can include various suitable types of hardware/software elements such as a network interface card, a virtual router, etc.

The compiler 124 can be configured to compile some or all of the posts 116 by the first user 101a into a video or slideshow upon receiving the animation command 121. In certain embodiments, the compiler 124 can first identify any or all of the posts 116 to be included in the video, for instance, from the folder 114 corresponding to the first user 101a at the network storage 112. In certain implementations, the first user 101a can select a subset of the posts 116 for the compilation based on certain criteria. For example, the compiler 124 can be configured to allow the first user 101a to select a date/time range of posts 116 to be included in the video. In other examples, the compiler 124 can also be configured to allow the first user 101a to select a subset of the posts 116 based on one or more of a message type (e.g., original posts or response post), a message topic (e.g., weather, school, etc.), or content type (e.g., only textual content).

Once the posts 116 to be included are identified, the compiler 124 can be configured to convert data of the identified posts 116 into a suitable format of one or more frames of the video. Example formats can include Windows Media Video, MP4, AVI, etc. In certain implementations, the compiler 124 can also be configured to apply various processing operations to various types of content in the posts. For example, textual content in a post may be condensed to only show a beginning portion of a threshold number of characters. In another example, pictorial content may be processed with lossy compression to derive a thumbnail version of the pictorial content be included in a frame instead of an original version of the pictorial content. In further examples, video content may be shortened and/or compressed to show a beginning portion of a threshold duration (e.g., 10 seconds). In yet further examples, additional and/or different types of content may be filtered, converted, or otherwise altered suitably in order to derive a playable frame.

Once the frames are generated, the compiler 124 can be configured to optionally insert or add data representing transition between consecutive frames. Example transitions can include fade in, fade out, morph, etc. Optionally, the compiler 124 can also be configured to add data representing sound, commentary, or other suitable information to the video and/or adjusting one or more of a playback speed, transition event, or other control features.

Upon completion of compiling the video, as shown in FIG. 2B, the compiler 124 can provide a copy of the video (shown as animation 128) to the client device 102 and optionally store another copy of the video in the network storage 112. In response to receiving the animation 128, the client device 102 can present the animation 128 to the first user 101a in the user interface 107. In the illustrated example, during playback of the animation 128, the user interface 107 can present navigational interface elements such as “Play” and “Pause” as well as modification interface elements such as “Edit” and “Delete” buttons 134, 135, 136, and 137. The navigational interface elements can cooperate with the controller 126 that is configured to pause, resume, fast forward, rewind, or perform other suitable navigational operations on the animation 128.

The user interface 107 can also playback the animation 128 frame by frame with optional transitions between consecutive frames 140. For instance, in the illustrated example, a first frame 140 can show two posts 116 (i.e., “Post 1” and “Post 2”) while a second frame 140′ can show one post 116 (i.e., “Post 3”). In other examples, each frame 140 can show three, four, or any other suitable numbers of posts 116.

During playback of the animation 128, the first user 101a can pause the playback by actuating the “Pause” button 135, as shown in FIG. 2C. Once paused, the first user 101a can also edit or delete any post(s) 116 shown in a current frame 140. In the example shown in FIG. 2C, the first user 101a provides another input to actuate the “Delete” button 137 when the current frame 140′ shows only one post 116 (i.e., “Post 3). In response to receiving the input, the user interface 107′ (and/or other components of the client device 102) can generate and transmit to the software video compiler 120 a command 129 to alter the post(s) 116.

As shown in FIG. 2D, in certain implementations, upon receiving the command 129, the interface component 122 can forward the command 129 to the compiler 124 for re-compiling the animation 128. For example, the compiler 124 can be configured to re-compile the posts 116 without the deleted post 116 (i.e., “Post 3) to re-generate another animation 128′ and provide the re-generated animation 128′ to the client device 102 for continued playback on the client device 102. In other examples, the compiler 124 can re-compile the posts 116 upon receiving another user input, upon detecting an operational event (e.g., playback stop), or based on other suitable criteria.

Several embodiments of the disclosed technology can thus provide an efficient technique for the first user 101a to browse through a large number of posts 116 on the timeline 109 without requiring the first user 101a to scroll through the large number of posts 116 via multiple user inputs. Instead, with a single click on the “Play” button 134, the first user 101a can be presented with an animation 128 of the posts 116 on the timeline 109. The animation 128 automatically scrolls through the posts 116 without further user input. During playback of the animation, when the first user 101a is presented with a desired post, the first user 101a can also pause the playback and optionally perform deletion, modification, or other suitable actions on the post 116. As such, embodiments of the software video compiler 120 can provide enhanced user experience of the social networking service when communicating with other users 101 on the social network.

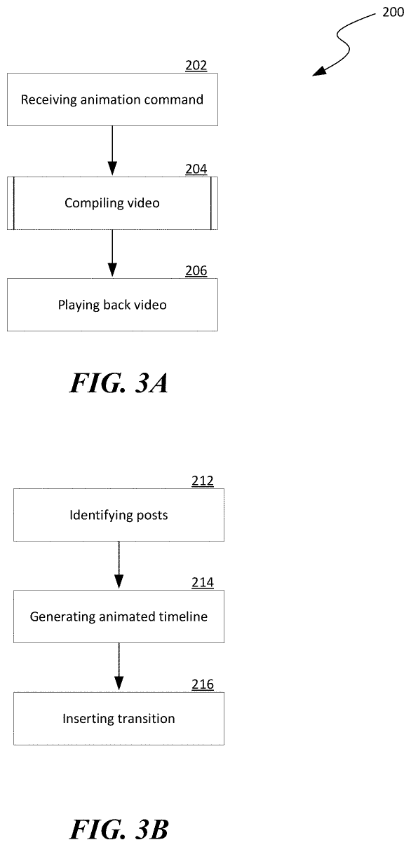

FIGS. 3A and 3B are flowcharts illustrating processes of animation of user timeline in accordance with embodiments of the disclosed technology. Even though the processes are described below with reference to the computing system 100 of FIG. 1, in other embodiments, the processes may also be implemented in other computing systems with similar and/or different components.

As shown in FIG. 3A, a process 200 can include receiving an animation command from a user, for example, via the user interface 107 of FIG. 2A, at stage 202. The process 200 can then include compiling posts of the user into a video at stage 204. Example operations of compiling the posts are described in more detail below with reference to FIG. 3B. The process 200 can then include transmitting data representing the video to be presented on, for instance, the user interface 107 on the client device 102 of FIG. 2A.

FIG. 3B illustrates example operations of compiling the posts into a video file. As shown in FIG. 3B, the example operations can include identifying posts from the user to be compiled into the video at stage 212, as described with reference to FIGS. 2A-2D. The example operations can also include generating an animated timeline at stage 214, as described with reference to FIGS. 2A-2D. In addition, the example operations can also include optionally inserting data representing transitions, sound, commentary, or other suitable information, at stag 216, as described with reference to FIGS. 2A-2D.

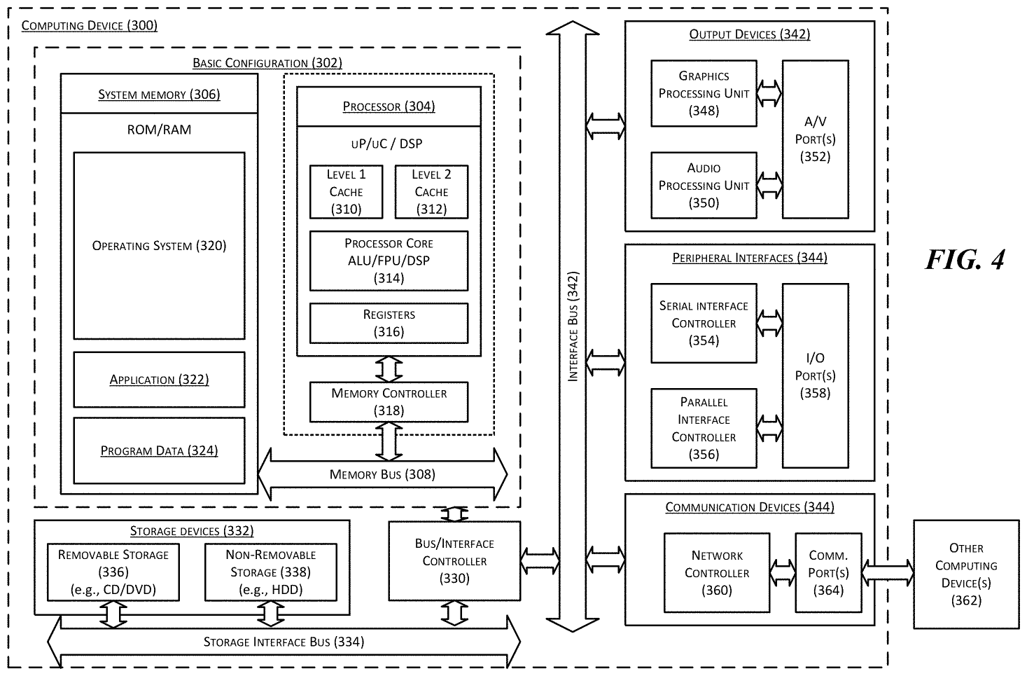

FIG. 4 is a computing device 300 suitable for certain components of the computing system 100 in FIG. 1. For example, the computing device 300 can be suitable for the computer servers 106 or the client devices 102 of FIG. 1. In a very basic configuration 302, the computing device 300 can include one or more processors 304 and a system memory 306. A memory bus 308 can be used for communicating between processor 304 and system memory 306.

Depending on the desired configuration, the processor 304 can be of any type including but not limited to a microprocessor (μP), a microcontroller (μC), a digital signal processor (DSP), or any combination thereof. The processor 304 can include one more levels of caching, such as a level-one cache 310 and a level-two cache 312, a processor core 314, and registers 316. An example processor core 314 can include an arithmetic logic unit (ALU), a floating-point unit (FPU), a digital signal processing core (DSP Core), or any combination thereof. An example memory controller 318 can also be used with processor 304, or in some implementations, memory controller 318 can be an internal part of processor 304.

Depending on the desired configuration, the system memory 306 can be of any type including but not limited to volatile memory (such as RAM), non-volatile memory (such as ROM, flash memory, etc.) or any combination thereof. The system memory 306 can include an operating system 320, one or more applications 322, and program data 324. This described basic configuration 302 is illustrated in FIG. 4 by those components within the inner dashed line.

The computing device 300 can have additional features or functionality, and additional interfaces to facilitate communications between basic configuration 302 and any other devices and interfaces. For example, a bus/interface controller 330 can be used to facilitate communications between the basic configuration 302 and one or more data storage devices 332 via a storage interface bus 334. The data storage devices 332 can be removable storage devices 336, non-removable storage devices 338, or a combination thereof. Examples of removable storage and non-removable storage devices include magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media can include volatile and nonvolatile, removable and non-removable media implemented in any method or technology for storage of information, such as computer readable instructions, data structures, program modules, or other data. The term “computer readable storage media” or “computer readable storage device” excludes propagated signals and communication media.

The system memory 306, removable storage devices 336, and non-removable storage devices 338 are examples of computer readable storage media. Computer readable storage media include, but not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other media which can be used to store the desired information and which can be accessed by computing device 300. Any such computer readable storage media can be a part of computing device 300. The term “computer readable storage medium” excludes propagated signals and communication media.

The computing device 300 can also include an interface bus 340 for facilitating communication from various interface devices (e.g., output devices 342, peripheral interfaces 344, and communication devices 346) to the basic configuration 302 via bus/interface controller 330. Example output devices 342 include a graphics processing unit 348 and an audio processing unit 350, which can be configured to communicate to various external devices such as a display or speakers via one or more A/V ports 352. Example peripheral interfaces 344 include a serial interface controller 354 or a parallel interface controller 356, which can be configured to communicate with external devices such as input devices (e.g., keyboard, mouse, pen, voice input device, touch input device, etc.) or other peripheral devices (e.g., printer, scanner, etc.) via one or more I/O ports 358. An example communication device 346 includes a network controller 360, which can be arranged to facilitate communications with one or more other computing devices 362 over a network communication link via one or more communication ports 364.

The network communication link can be one example of a communication media. Communication media can typically be embodied by computer readable instructions, data structures, program modules, or other data in a modulated data signal, such as a carrier wave or other transport mechanism, and can include any information delivery media. A “modulated data signal” can be a signal that has one or more of its characteristics set or changed in such a manner as to encode information in the signal. By way of example, and not limitation, communication media can include wired media such as a wired network or direct-wired connection, and wireless media such as acoustic, radio frequency (RF), microwave, infrared (IR) and other wireless media. The term computer readable media as used herein can include both storage media and communication media.

The computing device 300 can be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. The computing device 300 can also be implemented as a personal computer including both laptop computer and non-laptop computer configurations.

From the foregoing, it will be appreciated that specific embodiments of the disclosure have been described herein for purposes of illustration, but that various modifications may be made without deviating from the disclosure. In addition, many of the elements of one embodiment may be combined with other embodiments in addition to or in lieu of the elements of the other embodiments. Accordingly, the technology is not limited except as by the appended claims.

I/We claim:

1. A method of animating user timeline in a computing system configured to provide computing services for publishing electronic messages to one or more users of a social network, the method comprising:
receiving, at a client device, a command to animate a timeline of a user from the user, the timeline including a plurality of electronic messages published by the user on the social network;
transmitting, via a computer network, the received command from the client device to the computing system; and
in response to receiving the command, at the computing system,
identifying one or more of the electronic messages published by the user on the social network to be included in the animated timeline;
upon identifying the electronic messages to be included in the animated timeline, generating the animated timeline by compiling the identified electronic messages into multiple frames of a video; and
transmitting, via the computer network, data representing the video having the frames each containing one or more of the identified electronic messages to the client device; and
presenting to the user on the client device the transmitted video, thereby automatically presenting the identified electronic messages on the client device to the user without additional input from the user to advance the electronic messages.

2. The method of claim 1 wherein identifying one or more of the electronic messages includes identifying a subset of the electronic messages according to one or more of a date/time range, a message type, a message topic, or a content type of content included in the individual electronic messages.

3. The method of claim 1 wherein compiling the identified electronic messages includes:
converting the identified electronic messages into the multiple frames individually containing one or more of the identified electronic messages; and
adding data representing image transition between consecutive frames.

4. The method of claim 1, further comprising:
during playback of the video to the user,
receiving, at the client device, an input from the user to modify or delete one of the electronic messages; and
in response to receiving the input, at the computing system, re-generating the animated timeline by re-compiling the identified electronic messages into multiple frames of the video with the modified electronic message upon receiving another user command.

5. A computing system configured to provide computing services for publishing electronic messages to one or more users of a social network, the computing system comprising:
a processor; and
a memory containing instructions executable by the processor to cause the computing system to:
receive, via a computer network, a command to play a plurality of posts published by the user on the social network; and
in response to receiving the command, with the processor, identify the posts published by the user on the social network;
upon identifying the posts, compile the identified posts of the user into multiple frames of a video, the individual frames containing one or more of the posts; and
transmit, via the computer network, data representing the video having the multiple frames each containing one or more of the identified posts to be presented to the user on a client device, thereby automatically presenting the identified posts on the client device to the user without additional input from the user to advance the posts.

6. The computing system of claim 5 wherein to identify the posts includes identifying a subset of the posts published by the user on the social network according to one or more of a date/time range of publishing the posts.

7. The computing system of claim 5 wherein to compile the identified posts includes to:
convert the identified posts into the multiple frames individually containing one or more of the identified posts; and
add data representing image transition between consecutive frames.

8. The computing system of claim 5 wherein to compile the identified posts includes to:
convert the identified posts into the multiple frames individually containing one or more of the posts according to a date/time of publishing the posts on the social network by the user; and
adding data representing image transition between consecutive frames.

9. The computing system of claim 5 wherein to compile the identified posts includes to:
determine a content type of content contained in one of the identified posts; and
in response to determining that the content type is textual, condense the textual content to only show a beginning portion of a threshold number of characters of the textual content.

10. The computing system of claim 5 wherein to compile the identified posts includes to:
determine a content type of content contained in one of the identified posts; and
in response to determining that the content type is pictorial, derive a thumbnail version of the pictorial content to be included in the frame instead of an original version of the pictorial content.

11. The computing system of claim 5 wherein to compile the identified posts includes to:
determine a content type of content contained in one of the identified posts; and
in response to determining that the content type is video, shorten the video content to a beginning portion of a threshold duration to be included in the frame instead of a full length of the video content.

12. The computing system of claim 5 wherein the memory contains additional instructions executable by the processor to cause the computing system to:
during playback of the video to the user, upon receiving, via the computer network,
an input from the user to delete one of the posts from one of the frames of the video,
re-generate the animated timeline by re-compiling the identified posts into multiple frames of another video without the deleted electronic message; and
re-transmit, via the computer network, data representing the another video, thereby automatically presenting the identified posts on the client device to the user without the deleted electronic message.

13. A method of animating user timeline in a computing system configured to provide computing services for publishing electronic messages to one or more users of a social network, the method comprising:
receiving, via a computer network, a command to animate a timeline of a user from a client device of the user, the timeline including a plurality of electronic messages published by the user on the social network; and
in response to receiving the command, at the computing system,
identifying one or more of the electronic messages published by the user on the social network and to be included in the animated timeline;
upon identifying the electronic messages to be included in the animated timeline, generating the animated timeline by compiling the identified electronic messages into multiple frames of a video; and
transmitting, via the computer network, data representing the video having the frames each containing one or more of the identified electronic messages to be presented to the user on the client device, thereby automatically presenting the identified electronic messages on the client device to the user without additional input from the user to advance the electronic messages.

14. The method of claim 13 wherein identifying one or more of the electronic messages includes identifying a subset of the electronic messages according to one or more of a date/time range, a message type, a message topic, or a content type of content included in the individual electronic messages.

15. The method of claim 13 wherein compiling the identified electronic messages includes:
converting the identified electronic messages into the multiple frames individually containing one or more of the identified electronic messages; and
adding data representing image transition between consecutive frames.

16. The method of claim 13 wherein compiling the identified electronic messages includes:
converting the identified electronic messages into the multiple frames individually containing one or more of the electronic messages according to a date/time of publishing the electronic messages on the social network by the user; and
adding data representing image transition between consecutive frames.

17. The method of claim 13 wherein compiling the identified electronic messages includes:
determining a content type of content contained in one of the identified electronic messages; and
in response to determining that the content type is textual, condensing the textual content to only show a beginning portion of a threshold number of characters of the textual content.

18. The method of claim 13 wherein compiling the identified electronic messages includes:
determining a content type of content contained in one of the identified electronic messages; and
in response to determining that the content type is pictorial, deriving a thumbnail version of the pictorial content to be included in the frame instead of an original version of the pictorial content.

19. The method of claim 13 wherein compiling the identified electronic messages includes:
determining a content type of content contained in one of the identified electronic messages; and
in response to determining that the content type is video, shortening the video content to a beginning portion of a threshold duration to be included in the frame instead of a full length of the video content.

20. The method of claim 13, further comprising:
during playback of the video to the user,
receiving, via the computer network, an input from the user to delete one of the electronic messages from one of the frames of the video; and
in response to receiving the input,
re-generating the animated timeline by re-compiling the identified electronic messages into multiple frames of another video without the deleted electronic message; and
re-transmitting, via the computer network, data representing the another video, thereby automatically presenting the identified electronic messages on the client device to the user without the deleted electronic message.
